(19) United States
(12) Patent Application Publication
(10) Pub. No.: US 2020/0181536 A1
(43) Pub. Date: Jun. 11, 2020

(54) DETERGENT ADDITIVE

(71) Applicant: Dow Global Technologies LLC, Midland, MI (US)

(72) Inventors: Xue Chen, Manvel, TX (US); Xin Jin, Berwyn, PA (US); Gyongyi Gulyas, Lake Jackson, TX (US); Stephen W. King, League City, TX (US)

(21) Appl. No.: 16/632,886

(22) PCT Filed: Jul. 10, 2018
(86) PCT No.: PCT/US2018/041370

§ 371 Date: Jan. 22, 2020

Related U.S. Application Data
(60) Provisional application No. 62/539,166, filed on Jul. 31, 2017.

(51) Int. Cl. C11D 3/30; C11D 3/48; C11D 3/37; C11D 3/22

(52) U.S. Cl. CPC C11D 3/30; C11D 3/48; C11D 3/225; C11D 3/3757; C11D 3/3707

(57) ABSTRACT

A detergent additive comprising an active comprising one or both of tetraacetylethylenediamine, triacetylethylenediamine; and an interpolymer complex, the interpolymer complex comprising both a proton-accepting-(co)polymer and a proton-donating (co)polymer.

### BACKGROUND

Textiles, such as wearable fabrics, are typically washed by contacting the textiles with a detergent formulation that is a combination of detergent components and other optional actives, such as bleaching agents. For ease of use, many detergent formulation users prefer an all-in-one product that incorporates the detergents and optional actives into a single product. Further, many users prefer this product to be a liquid, as compared to a solid or granular product.

One common detergent active is tetraacetylethylenediamine (TAED). TAED functions as a peroxy bleaching activator and a microbial control agent. TAED has been extensively used in solid detergent products. TAED, in liquid detergent formulations which contain in part water, will undergo hydrolysis and lose effectiveness as a detergent active as the TAED reacts to form N, N′ diacetylethylenediamine (DAED), which is not effective as a detergent active. As such, TAED, when used without modification, is not ideal as an active for an aqueous detergent formulation. Triacetylethylenediamine (TriAED) is another detergent active. A detergent additive containing one or both of TAED or TriAED that is suitable for use in a liquid detergent formulations that contain water is desired.

### SUMMARY OF THE INVENTION

A detergent additive comprising an active comprising one or both of tetraacetylethylenediamine or triacetylethylenediamine; and an interpolymer complex, the interpolymer complex comprising both a proton-accepting-(co)polymer and a proton-donating (co)polymer.

### DETAILED DESCRIPTION OF THE INVENTION

The present disclosure describes an improved detergent additive. In one aspect, the present disclosure describes a detergent additive comprising an active, for example, tetraacetylethylenediamine (TAED), and an interpolymer complex. The interpolymer complex includes both a proton-accepting-(co)polymer and a proton-donating (co)polymer. As used herein “(co)polymer” refers to either a polymer or a copolymer. The improvement of the detergent additive described herein is increased hydrolytic stability for TAED which gives enhanced long-term stability in an aqueous detergent formulation. In the interpolymer complex the proton-donating (co)polymers associate with the proton-accepting (co)polymer via hydrogen bonding. The interpolymer network defines the structure of the additive described herein, wherein the additive encapsulates the active.

The proton-donating (co)polymer is selected from the group consisting of poly(meth)acrylic acid, carboxymethyl cellulose, ethylene acrylic acid copolymer, pectin, xanthan gum, and alginic acid. As used herein, “(meth)acrylic” refers to both acrylic and methacrylic functionalities.

The proton-accepting (co)polymer is a homo-polymer or co-polymer selected from one or more of the group consisting of polyethylene oxide, polyethylene glycol, polypropylene glycol, polypropylene oxide, ethylene oxide/propylene oxide copolymer, polyvinyl alcohol and methyl cellulose.

The ratio of the proton-donating (co)polymer to proton-accepting (co)polymer can be from 1:10 to 10:1 molar. The ratio of the proton-donating (co)polymer to proton-accepting (co)polymer is preferably from 1:5 to 5:1 molar. The ratio of the proton-donating (co)polymer to proton-accepting (co)polymer is more preferably from 1:2 to 2:1 molar. The weight average molecular weight of the proton-accepting (co)polymer is from 1,000 to 10,000,000. The weight average molecular weight of the proton-accepting (co)polymer is preferably from 5,000 to 5,000,000. The weight average molecular weight of the proton-accepting (co)polymer is more preferably from 10,000 to 1,000,000. The weight average molecular weight of the proton-donating (co)polymer is from 1,000 to 10,000,000. The weight average molecular weight of the proton-donating (co)polymer is preferably from 10,000 to 5,000,000. The weight average molecular weight of the proton-donating (co)polymer is more preferably from 100,000 to 1,000,000.

The detergent additive may be prepared by mechanical mixing of the proton-donating (co)polymer, the proton-accepting (co)polymer and the active. The detergent additive may also be prepared by spray-drying a solution of the proton-donating (co)polymer and the proton-accepting (co)polymer onto granules of the active. In some instances, surfactants are included in the detergent additive preparation to enhance encapsulation efficiency and uniformity. Examples of suitable surfactants are nonionic surfactants including aliphatic alcohol ethoxylates, alkyl phenol ethoxylates, fatty acid ester ethoxylates, alkylpolyglucosides, ethylene oxide/propylene oxide copolymers including random and block copolymers, polyols, and ethoxylated polyols. When choosing a nonionic surfactant, it is important to take into account the interaction of both the ethoxylated and the hydrophobic moieties of the surfactant with the interpolymer complex and the competition with the proton-accepting (co)polymer for the binding sites of the proton-donating (co)polymer.

During preparation of the Interpolymer Complex (IPC), the pH of the prepared solution determines the effectiveness of forming the IPC. The pH is varied by the type of the proton donating and accepting (co)polymer, the molecular weight of the proton donating and accepting (co)polymers, the extent of neutralization of the proton-donating (co)polymers, the types of other species (such as surfactants or inorganic salts) that are present, and the ratio of the proton donating and accepting (co)polymers and the quantity of the active selected. Preferably, the pH of the prepared solution is from 2 to 4 when the active is TAED or TriAED. The formation of the insoluble IPC complex is observed to be maximized in this pH range.

The detergent additive is 90 weight percent or less TAED and 10 weight percent or more interpolymer complex. In one instance, the detergent additive is 75 weight percent or less TAED and 25 weight percent or more interpolymer complex. Preferably, the detergent additive is 50 weight percent or less TAED and 50 weight percent or more interpolymer complex.

As described herein, the additive encapsulates, or partially encapsulates, the active. As used herein, “encapsulated” refers to the active being bound or retained within the interpolymer complex. The additives described herein are designed to release the active during a triggering event (in the context of the present disclosure, the triggering event might be use in a washing machine). When referring to the active being encapsulated, it refers to the active being retained within the interpolymer complex prior to the triggering event. The additives prepared according to the methods of the present disclosure have an encapsulating efficiency of 30 to 100 percent. Preferably, the additives prepared according to the methods of the present disclosure have an encapsulating efficiency of 60 to 100 percent. More preferably, the additives prepared according to the methods of the present disclosure have an encapsulating efficiency of 90 to 100 percent. As used herein, “encapsulating efficiency” refers to the percentage of prospective actives that are encapsulated in the interpolymer complex of the additive.

The detergent additive described herein has a better long-term stability in aqueous systems than TAED alone. When the detergent additive is used in a washing machine the TAED is released from the interpolymer complex, allowing the TAED to be available in the washing system to perform its peroxy bleach activating function.

The methods described herein are suitable for preparing other types of solid powder systems. For example, the methods described herein can include but are not limited to encapsulating fabric softening agents, detergent actives, bleach actives, fertilizers, micronutrients, pesticides (fungicides, bactericides, insecticides, acaricides, nematocides, and the like), biocides, microbial control agents, polymeric lubricants, fire retardants, pigments, dyes, urea inhibitors, food additives, flavorings, pharmaceutical agents, tissues, antioxidants, cosmetic ingredients (fragrances, perfumes and the like), soil amendments (soil repelling agents, soil release agents and the like), catalysts, diagnostic agents and photoprotective agents (UV blockers and the like).

### Examples

Materials and Examples Preparation

Materials

TAED solid was purchased from Sigma-Aldrich, and it was milled using an 80 μm sieve into powder. POLYOX Water-Soluble Resins WSR N-3000, WSR N-10 and WSR-205 were purchased from The Dow Chemical Company. WSR N-3000 and WSR N10 were separately dissolved in deionized water at 7 wt % concentration while WSR-205 was dissolved in deionized water at 5 w % concentration. The 35% polyacrylic acid (PAA) solution with a weight average molecular weight of 250,000 was purchased from Sigma-Aldrich. Methyl cellulose (MC) with a number-average molecular weight (Mn) of 40K was obtained from Sigma-Aldrich and was dissolved in deionized (DI) water at 2.5 wt % level at room temperature.

Experimental Procedure

Reagents and their amounts are summarized in Table 1. Encapsulations were carried out using two different procedures. Example 1 describes a blender based protocol while the rest of the samples were prepared in a stirred flask.

For Example 1, following the formulation listed in Table 1, the polymer solutions (the WSR N3000 and the PAA prepared as described above) were combined in a plastic container equipped with a mechanical stirrer and stirred at 2500 rpm for 10 minutes to provide a polymer blend. The TAED powder was added to a metal blender which was set at a medium speed and the polymer blend was added to it slowly. The mixture turned to a white paste after all of the polymer blend was added. Agitation was continued for 30 minutes. The contents were transferred to an aluminum pan and it was dried in a vacuum oven at reduced pressure at 40° C. for 16 hours. The obtained material is a white solid composite. It was ground into a fine powder by a metal blender with dry ice.

Examples 2-7 were prepared using the procedure described in this paragraph. Sample amounts are summarized in Table 1. TAED, PEO and methyl cellulose solutions were weighed in a 250 ml 3-neck flask equipped with a mechanical stirrer. The mixture was agitated at 2500 rpm for 2 minutes and then the agitation rate was lowered to 1000 rpm for another 2 minutes. The pre-determined amount of PAA solution was added to a 20 ml addition funnel and the funnel was attached to the flask. The PAA solution was added to the flask drop-wise with the agitation at 1000 rpm. After all the PAA solution is added, the mixture was agitated for 5 more minutes. The product was isolated by centrifugation and washed with DI water 3 times. The pH of the solution ranged from 2.5-2.8. The product was dried at room temperature as a thin layer. The obtained material is a white solid composite. It was ground into a fine powder by a metal blender with dry ice.

TABLE 1
Formulation Recipe of Examples (Ex)

| Formulation (g) | Ex 1 | Ex 2 | Ex 3 | Ex 4 | Ex 5 | Ex 6 | Ex 7 | Ex 8 |
|---|---|---|---|---|---|---|---|---|
| 7 wt % WSR | 0 | 0 | 0 | 0 | 0 | 100 | 0 | 0 |
| N10 | | | | | | | | |
| 5 wt % WSR | 0 | 0 | 0 | 0 | 0 | 0 | 100 | 0 |
| 205 | | | | | | | | |
| 7 wt % WSR | 20.3 | 90 | 90 | 90 | 90 | 0 | 0 | 90 |
| N3000 | | | | | | | | |
| 2.5% MC | 0 | 10 | 10 | 10 | 10 | 10 | 20 | 10 |
| TAED | 6.0 | 11.5 | 9.4 | 17.3 | 11.5 | 14 | 10 | 0 |
| 35% PAA | 2.0 | 15 | 9 | 15 | 18 | 20 | 14.3 | 15 |
| solution | | | | | | | | |
| PAA:PEO | 0.5 | 0.8 | 0.5 | 0.8 | 1.0 | 1.0 | 1.0 | 0.8 |
| g/g | | | | | | | | |
| TAED/ | 3 | 1 | 1 | 1.5 | 1 | 1 | 1 | n/a |
| polymer | | | | | | | | |

Material Characterizations

Differential Scanning Calorimetry

Differential Scanning calorimetry (DSC) measurement was carried out using a differential scanning calorimeter, model Q2000 from TA Instruments. Samples of 5-10 mg were placed in hermetically sealed pans and analyzed using 10° C./min scans from −50-200° C. The DSC measurement produced heat flow curves that verify the formation of the IPC by demonstrating the disappearance of the PEO melt endotherm as compared to comparison tests run with only PEO, only PAA, only TAED, and an IPC with no TAED.

### Effect of pH on IPC Formation

For the effect of pH on the interpolymer complex, reagent ratios described for Example 2 were used. The formulation was divided into three portions and TAED encapsulations were carried out in the same way as described for Examples 2-7, except the pH of the reaction mixtures were adjusted to 3, 5, and 8 using sodium hydroxide after complete addition of the PAA. In the case of pH=3, the resultant solid precipitates were isolated by centrifugation, dried and analyzed by DSC. At a higher pH (pH=5 and pH=8), the resultant solid was paste like. This aggregated solid was dried and also analyzed by DSC. DSC analysis only showed a PEO melt endotherm for the pH=3 formulation, whereas the pH=5 and pH=8 formulations did not show a PEO melt endotherm.

Without being limited by theory, a low pH favors hydrogen-bonding, whereas when PAA is deprotonated (in this case as the sodium salt), hydrogen-bonds cannot form.

HPLC analysis for determining hydrolysis of TAED to diacetylethylenediamine (DAED)

0.5 grams of raw TAED without encapsulation and encapsulated TAED powders from the above examples were added to 20 g All™ Mighty Pac™ detergent, and were shaken for 10 min. 1 droplet (ca. 0.1 g) of each mixture was separately added to 10 g 1:3 Acetonitrile/H2O solvent, and sonicated for 15 minutes to fully dissolve TAED solid. The concentration of DAED of the prepared samples was measured using an Agilent 1100 High-Performance Liquid Chromatography (HPLC) with quaternary pump and diode array detector. The HPLC method conditions are summarized in Table 2.

TABLE 2
HPLC Testing Conditions

| System | Agilent 1100 with quaternary | | |
|---|---|---|---|
| | pump and diode array detector | | |
| Column | Eclipse XDB-C18: 4.6 mm × 50 mm × | | |
| | 5 μm | | |
| Column | 40° C. | | |
| Temperature | | | |
| Injection | 1 μL sample | | |
| Volume | | | |
| Flow Rate | 1 mL/min | | |
| Mobile Phases | A = 18.2 MΩ-cm water, B = acetonitrile | | |
| Gradient | Time | Composition | |
| | (min) | % A | % B |
| | 0.0 | 65 | 35 |
| | 3.5 | 0 | 100 |
| | 5.5 | 0 | 100 |

| | |
|---|---|
| Equilibration | 2.5 min |
| Time | |
| Total Run | ~10 |
| Time | |
| Detection | UV (DAD) @ 216 nm, BW 4 nm, |
| | 1 cm cell (TAED) |
| | UV (DAD) @ 205 nm, BW 4 nm, |
| | 1 cm cell (DAED) |

TABLE 3
HPLC evaluation results of DAED %

| | Initial Day | Day 2 | Day 7 | Day 20 |
|---|---|---|---|---|
| | (%) | (%) | (%) | (%) |
| TAED without | 0 | 0.116 | 0.284 | 0.593 |
| encapsulation | | | | |
| Ex 1 | 0 | 0.059 | 0.146 | 0.269 |
| Ex 2 | 0 | 0.000 | 0.056 | 0.138 |
| Ex 3 | 0 | 0.000 | 0.054 | 0.133 |
| Ex 4 | 0 | 0.018 | 0.095 | 0.237 |
| Ex 5 | 0 | 0.036 | 0.110 | 0.236 |
| Ex 6 | 0 | 0.000 | 0.067 | 0.166 |
| Ex 7 | 0 | 0.012 | 0.069 | 0.175 |

As shown in Table 4, for TAED without any encapsulation, the DAED concentration is increasing dramatically, while for other examples which are encapsulated with an interpolymer complex, the DAED increased slowly. Since DAED is generated from TAED hydrolysis, the slow releasing profile of DAED indicates good encapsulation efficiency.

In addition, the encapsulation efficiency was not significantly affected by the molecular weight of PEO, as Example 5 (PEO Mw 400,000); Example 6 (PEO Mw 100,000) and Example 7 (PEO Mw 600,000) have very similar DAED concentrations. Examples 2 and 4, as well as Examples 1 and 3, illustrate that even with increasing the amount of TAED it was efficiently encapsulated by the interpolymer complex. Varying the PAA to PEO ratios, Examples 2, 3, and 5, also resulted in effective encapsulation.

1. A detergent additive comprising:
an active comprising one or both of tetraacetylethylenediamine or triacetylethylenediamine; and
an interpolymer complex, the interpolymer complex comprising both a proton-accepting-(co)polymer and a proton-donating (co)polymer;
wherein the detergent additive comprises 25 weight percent or less of the active and 75 weight percent or more of the interpolymer complex.

2. The detergent additive of claim 1, wherein the proton-donating (co)polymer is selected from the group consisting of poly(meth)acrylic acid, carboxymethyl cellulose, ethylene acrylic acid copolymer, pectin, xanthan gum, and alginic acid.

3. The detergent additive of claim 1, wherein the proton-accepting (co)polymer is a homo-polymer or co-polymer selected from one or more of the group consisting of polyethylene oxide, polyethylene glycol, polypropylene glycol, polypropylene oxide, ethylene oxide/propylene oxide copolymer, polyvinyl alcohol and methyl cellulose.

4. The detergent additive of any one of claims 1 to 3, comprising 90 weight percent or less of the active and 10 weight percent or more of the interpolymer complex.

5. The detergent additive of any one of claims 1 to 4, comprising 25 weight percent or less of the active and 75 weight percent or more of the interpolymer complex.

6. The detergent additive of any one of claims 1 to 5, comprising 90 weight percent or less of the active and 10 weight percent or more of the interpolymer complex.

7. The detergent additive of any one of claims 1 to 6, comprising 25 weight percent or less of the active and 75 weight percent or more of the interpolymer complex.

8. The detergent additive of claim 1, wherein the pH of the detergent additive is from 2 to 4.

9. The detergent additive of claim 1, wherein the encapsulating efficiency of the active in the additive is from 60 to 100 percent.
